(19) United States
(12) Patent Application Publication
(10) Pub. No.: US 2010/0302979 A1
(43) Pub. Date: Dec. 2, 2010

(54) POWER SAVING IN WIRELESS COMMUNICATION

(75) Inventor: Jukka REUNAMÄKI, Tampere (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/473,400

(22) Filed: May 28, 2009

(51) Int. Cl. G08C 17/00

(52) U.S. Cl. 370/311

(57) ABSTRACT

Method, apparatus, and computer program product embodiments are disclosed to improve power saving in wireless communication, more particularly in the Bluetooth Low Energy protocol. Conventional Bluetooth packets include a preamble used for radio synchronization, an access address used for physical link identification, a protocol data unit (PDU) to carry the data and a cyclic redundancy code (CRC) to ensure correctness of the data in the PDU. When the sending device determines that it does not have any payload data or acknowledgment to previous data to send and yet it wants to keep the communication link alive with the receiving device, the sending device takes the following steps. The sending device uses a predefined access address in the Bluetooth packet, which is different from normal Bluetooth communication. Then the sending device omits including the PDU and the CRC in the packet. At the receiving device, the presence of the predefined access address in the Bluetooth packet indicates to the receiving device to keep the communication link alive when there is no actual payload data traffic between the devices. The predefined access address serves as an indication to the receiving device to keep the connection between the devices active/alive, but to not expect any payload data from the sending device.

### FIELD

The field of the invention relates to power saving in wireless communication.

### BACKGROUND

Perhaps the best-known example of wireless personal area network (PAN) technology is Bluetooth Standard, which operates in the 2.4 GHz ISM band. Bluetooth is a short-range radio network, originally intended as a cable replacement. Bluetooth Technical Specifications are published by the Bluetooth SIG, Inc. Bluetooth Specification version 2.0+EDR published Oct. 15, 2004 has the original functional characteristics of the first version Bluetooth Specification and adds the Enhanced Data Rate (EDR) feature. Bluetooth Specification version 2.1+EDR published Jul. 26, 2007 added definitions for new features: Encryption Pause Resume, Erroneous Data reporting, Extended Inquiry Response, Link Supervision Timeout Event, Packet Boundary Flag, Secure Simple Pairing, Sniff Subrating. Bluetooth Specification version 3.0+HS published Apr. 21, 2009, updated the standard to integrate the Alternate MAC/PHY and Unicast Connectionless Data features.

On Apr. 20, 2009, Bluetooth SIG presented the new Bluetooth Low Energy protocol. Bluetooth Low Energy is a communication protocol directed to optimize power consumption of devices while being connected to other devices. The Bluetooth Low Energy packets include a preamble used for radio synchronization, an access address used for physical link identification, a protocol data unit (PDU) to carry the payload data and the PDU header information, and a cyclic redundancy code (CRC) to ensure correctness of the data in the PDU.

### SUMMARY

Method, apparatus, and computer program product embodiments are disclosed to improve power saving in wireless communication, more particularly in the Bluetooth Low Energy protocol. Conventional Bluetooth Low Energy packets include a preamble used for radio synchronization, an access address used for physical link identification, a protocol data unit (PDU) to carry the data and a cyclic redundancy code (CRC) to ensure correctness of the data in the PDU.

When the sending device determines that it does not have any payload data to send and yet it wants to keep the communication link alive with the receiving device, the sending device takes the following steps. The sending device uses a predefined access address in the Bluetooth Low Energy packet, which is different from normal Bluetooth Low Energy communication. Then the sending device omits including the PDU and the CRC in the packet. At the receiving device, the presence of the predefined access address in the Bluetooth Low Energy packet indicates to the receiving device to keep the communication link alive when there is no actual payload data traffic between the devices. The predefined access address serves as an indication to the receiving device to keep the connection between the devices active/alive, but to not expect any payload data from the sending device.

In an example embodiment, a method includes the steps of:

determining, at a sending device having a wireless communication link with a receiving device, that information to be sent in an upcoming transmission slot to the receiving device is already known or derivable by the receiving device;

constructing a shortened packet including a packet preamble field providing link synchronization information to the receiving device for remaining synchronized with the sending device and an access address field including an indicium to signal to the receiving device that said information already known or derivable by the receiving device has been omitted in the shortened packet; and

transmitting the shortened packet to the receiving device.

In another example embodiment, a method includes the steps of:

receiving at a receiving device a packet from a sending device;

detecting an indicium in the packet indicating that information already known or derivable by the receiving device has been omitted in the packet, indicating that the packet is shortened so that a field that would otherwise have contained information already known or derivable by the receiving device has been omitted, and indicating that the receiving device must remain synchronized with the sending device; and

remaining synchronized with sending device.

When the sending device determines that it will send a Bluetooth low energy protocol packet in the next transmission slot, if the packet only contains unnecessary information that is already known by the receiving device or which can be derived by the receiving device without inspecting the PDU, then the sending device may shorten the packet by omitting the unnecessary information. The shortened condition of the packet will be indicated by using an alternate address for the shortened packet. When the receiving device receives this shortened packet bearing the alternate address, the receiving device may infer the omitted information because it is already known to the receiving device or can be derived by the receiving device.

In this manner, significant power and interference savings is gained, since there is no need to transmit and receive PDU data elements containing merely header part of the PDU without of payload data part. And, since there is no PDU in the packet, there is no need for a CRC in the packet to ensure correctness of the data.

### DESCRIPTION OF THE FIGURES

FIG. 1 is an example embodiment of a wireless network using the Bluetooth Low Energy protocol, enabling communication between a wireless sensor or controller and a wireless device, such as a cellular telephone.

FIG. 2 is an example embodiment of the internal architecture of the wireless sensor or controller and the wireless device of FIG. 1.

FIG. 3 is an example packet structure of Bluetooth Low Energy protocol, when it is carrying payload data according to at least one embodiment.

FIG. 4 is an example packet structure of the Bluetooth Low Energy protocol, when it is not carrying payload data according to at least one embodiment.

FIG. 5 is an example flow diagram of a procedure at a master device using the Bluetooth Low Energy protocol according to at least one embodiment.

FIG. 6 is an example flow diagram of a procedure at a slave device using the Bluetooth Low Energy protocol according to at least one embodiment.

FIG. 7 is an example of the Bluetooth Low Energy packet carrying payload data, as indicated by using a normal access address, according to at least one embodiment.

FIG. 8 is an example of the shortened Bluetooth Low Energy packet without payload data, as indicated by using an alternate access address, according to at least one embodiment.

FIG. 9 is an example flow diagram of a procedure at a master device for communicating in the Bluetooth Low Energy protocol with a slave device according to at least one embodiment.

FIG. 10A is an example flow diagram of a procedure at a slave device for detecting a shortened packet according to at least one embodiment

FIG. 10B is an example flow diagram of a procedure at a slave device for replying to the master device with a shortened packet according to at least one embodiment.

FIG. 11 is an example flow diagram of a procedure at a slave device for detecting either a full packet or a shortened packet and replying to the master device with either a full packet or a shortened packet according to at least one embodiment.

FIG. 12 is an example flow diagram of a procedure at both the slave device and the master device to determine if there is data or relevant information to send using the Bluetooth low energy protocol according to at least one embodiment.

### DISCUSSION OF EXAMPLE EMBODIMENTS OF THE INVENTION

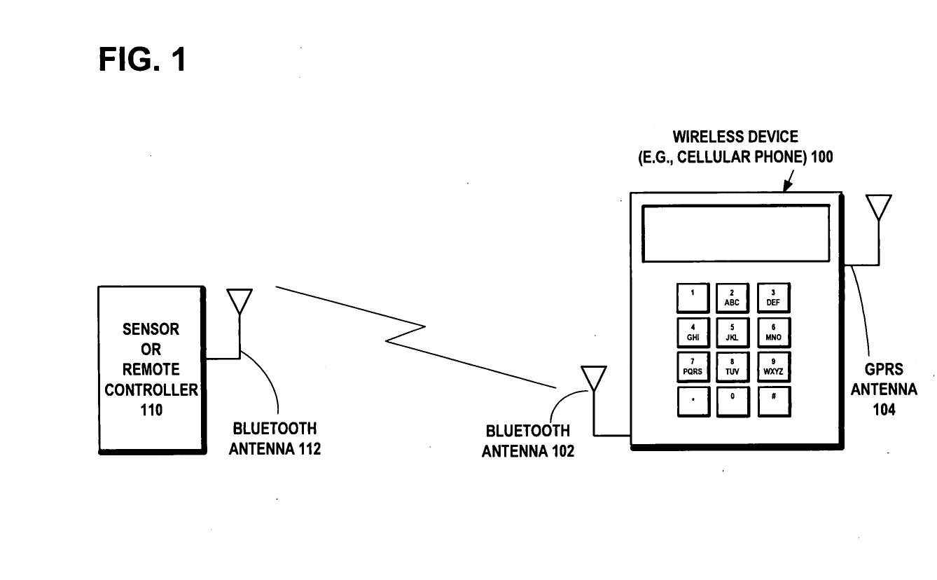

FIG. 1 is an example embodiment of a wireless network using the Bluetooth Low Energy protocol, enabling communication between a wireless sensor or controller 110 and its Bluetooth antenna 112 and a wireless device, such as a cellular telephone 100 with a Bluetooth antenna 102 and a cellular GPRS antenna 104. As the Bluetooth Low Energy protocol is designed for applications with strict power consumption requirements, devices using Bluetooth Low Energy protocol consume less power than Bluetooth devices using the older Bluetooth protocol of Basic Rate/Enhanced Data Rate (BR/EDR). An objective is to enable isolated devices such as temperature sensors to operate more than a year on a button cell battery without recharging.

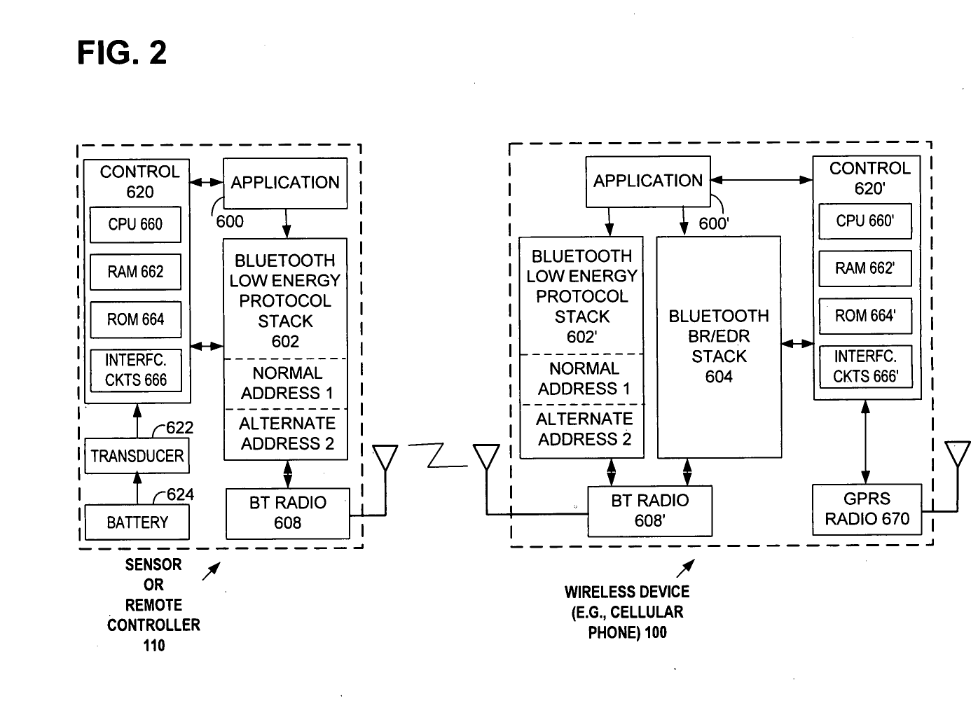

FIG. 2 is an example embodiment of the internal architecture of the wireless sensor or controller 110 and the wireless device 100 of FIG. 1. The wireless device 100 may be a communications device, PDA, cell phone, laptop or palmtop computer, or the like or it may be a stationary access point, automotive dashboard interface, home electronics interface or other stationary interface or device. The sensor or controller 110 may be a remote controller, healthcare monitor, sports sensor, token, key fob, watch, wireless keyboard, gaming pad, body sensor, toy, health care equipment, human interface device, entertainment device, wireless microphone, GPS sensor, or the like. Both the wireless sensor or controller 110 and the wireless device 100 may include a control module 620, which includes a central processing unit (CPU) 660, a random access memory (RAM) 662, a read only memory (ROM) 664, and interface circuits 666 to interface with the radio transceiver 608. Both of the wireless sensor or controller 110 and the wireless device 100 may further include a battery and other power sources, key pad, touch screen, display, microphone, speakers, ear pieces, camera or other imaging devices, etc. The wireless sensor or controller 110 may further include a transducer 622 and a battery 624. The RAM 662 and ROM 664 may be removable memory devices such as smart cards, SIMs, WIMs, semiconductor memories such as RAM, ROM, PROMS, flash memory devices, etc. according to an embodiment of the present invention. According to an embodiment, both the wireless sensor or controller 110 and the wireless device 100 include the Bluetooth Low Energy protocol stack 602, which is described in the Bluetooth SIG draft Bluetooth Low Energy protocol specification. The wireless device may 100 also include the Bluetooth BR/EDR protocol stack 604, which is described in the Bluetooth Specification version 3.0+HS.

The control module 620, protocol Bluetooth protocol stacks 602 and 604 and/or application program 600 may be embodied as program logic stored in the RAM 662 and/or ROM 664 in the form of sequences of programmed instructions which, when executed in the CPU 660, carry out the functions of the disclosed embodiments. The program logic may be delivered to the writeable RAM, PROMS, flash memory devices, etc. 662 of the wireless device 100 from a computer program product or article of manufacture in the form of computer-usable media such as resident memory devices, smart cards or other removable memory devices, or in the form of program logic transmitted over any transmitting medium which transmits such a program. Alternately, they may be embodied as integrated circuit logic in the form of programmed logic arrays or custom designed application specific integrated circuits (ASIC). The Bluetooth radio 608 in the wireless sensor or controller 110 and the wireless device 100 may be separate transceiver circuits or alternately, the radio 608 may be a single radio module capable of handling one or multiple channels in a high speed, time and frequency multiplexed manner in response to the control module 620. The program code for instructing the apparatus to perform its various operations may be stored in computer readable media, for example magnetic disks, CD ROMS, or flash memory devices. The program code may be downloaded from such computer readable media to be stored for example in the RAM 662 or programmable ROM 664 of the wireless device 100 or 110 for execution of the program code for example by the processor 660.

The GPRS radio 670 in the wireless device 100 may be any of a variety of wireless personal area, wireless local area, or wireless wide area radio devices, such as Land Mobile Radio, Professional Mobile Radio, DECT (Digital Enhanced Cordless Telecommunications), 1G, 2G, 3G, 4G Cellular systems, IrDA, RFID (Radio Frequency Identification), Wireless USB, DSRC (Dedicated Short Range Communications), Near Field Communication, wireless sensor networks, ZigBee, EnOcean; Bluetooth, TransferJet, Ultra-wideband (UWB from WiMedia Alliance), WLAN, IEEE 802.11, WiFi, HiperLAN, Wireless Metropolitan Area Networks (WMAN) and Broadband Fixed Access (BWA) (LMDS, WiMAX, AIDAAS and HiperMAN), or the like.

A memory register 610, which may be a partition in the memory RAM 662, may store the values for the normal address 1 and the alternate address 2 negotiated between the devices 100 and 110.

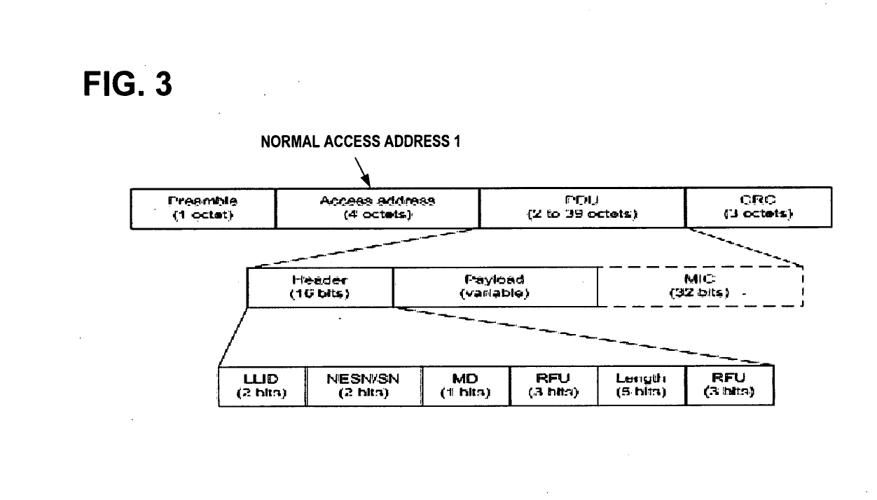

FIG. 3 is an example packet structure of the Bluetooth Low Energy protocol, when it is carrying payload data according to at least one embodiment. All data communication in the connected state is controlled by the master device, where master and slave devices are able to exchange data packets. A connection event always starts with the packet from the master. The packet includes an 8-bit the preamble used for radio synchronization. The preamble is a fixed zero-one pattern of symbols used to facilitate DC compensation. The packet also includes a 32-bit field for the access address used to identify physical connection between any two devices. The access address is pseudo-random 32-bit value, generated by the master device in a connection setup phase. The access address is different for each physical connection currently active. The packet also includes the protocol data unit (PDU) field that carries the payload data and header information. The protocol data unit (PDU) field includes a 16-bit header field, a variable length payload field, and may include an optional 32-bit MIC field. The packet also includes a 24-bit cyclic redundancy code (CRC) field to insure correctness of the PDU.

Example low energy applications and products, such as, for example, a remote control or a temperature sensor, are required to operate for long periods on a button cell battery without recharging. These applications typically have a low level of data traffic, since most of the transmitted packets do not carry any payload data. However, latency requirements of the applications may require sending packets without payload data to maintain wireless connection between devices when there is no data traffic to transmit, requiring energy for transmission of the PDU header and the CRC.

In the case of a packet that does not carry payload data, the preamble and access address are needed to get radio synchronization and identify the link. However, most of the information currently required to be included in the otherwise empty PDU information is not necessary to maintain the wireless connection between devices. According to at least one embodiment, at least some of the following fields may be considered as superfluous information in connection with the Bluetooth Low Energy embodiment of the present invention:

1. Logical link identifier (LLID) is used to indicate whether packet is control or data packet; an empty packet is always data packet.

2. Next expected sequence number (NESN) and Sequence Number (SN) are used for acknowledgement scheme; in the case where there is no need for acknowledgement of payload data, these are needed only to keep acknowledgment scheme running. The acknowledgement scheme may be paused when sending or receiving shortened packets according to at least one embodiment of the present invention.

3. More data (MD) is used to control the closing of the connection events, when power consumption is to be reduced. If there is no payload data to transfer, this is constant.

4. Length to indicate the length of the payload; where zero stands for an empty packet.

5. Reserved future use (RFU) bits are reserved for future use and are not used.

Bluetooth Low Energy protocol packets are transmitted using frequency-hopping spread spectrum to distribute the packets over up to 40 frequencies in the ISM band. Adaptive frequency-hopping is used to improve resistance to radio frequency interference by avoiding the use of crowded frequencies in the hopping sequence.

A Time-Division Duplex (TDD) scheme is used where master and slave devices alternately transmit. The master may have full control over the communication so that slaves only communicate with the master and not other slaves. A slave may only be allowed to transmit when addressed by the master.

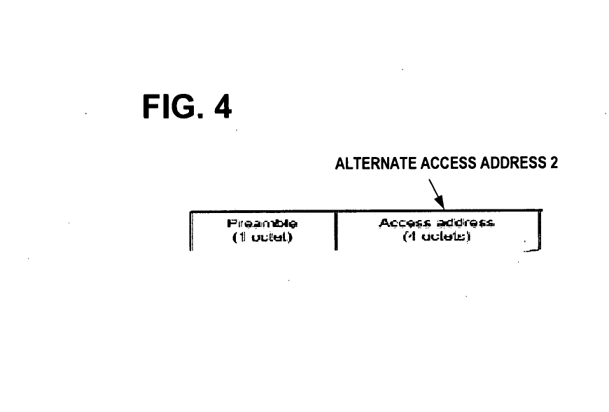

FIG. 4 is an example shortened packet structure of the Bluetooth Low Energy protocol, when it is not carrying payload data according to at least one embodiment. In use cases where latency requirements are high but the data traffic is low as explained above, many of the transmitted packets do not have payload data and necessary information is included in the access code that is used to synchronize the packet communication. Thus the minimum overhead of 5 octets is present in every packet, which is approximately 50% of the total traffic.

Thus, a significant reduction in power consumption and interference creation may be realized by shortening the packet length according to one or more embodiments of the present invention when there is no payload data or relevant PDU header information to send, while keeping the communication link alive with the receiving device. According to at least one embodiment, when the master device does not have any payload data or relevant PDU header information to be sent to the slave device, it may use an alternate access address different from the normal address, to indicate to the slave device that the packet does not contain payload data, that the packet is shortened, and that the slave device is to continue to maintain synchronization with the master device, allowing the slave device to respond.

When the slave device receives a packet from the master device with an alternate access address different from the normal address to indicate to the slave device that the packet does not contain payload data, that the packet is shortened, and that the slave device is to continue to maintain synchronization with the master device, allowing the slave device to respond.

When the slave device responds to the master device, if the packet sent by the slave device does not contain payload data or relevant PDU header information, the slave may insert an alternate access address different from the normal address to indicate to the master device that the packet does not contain payload data and that the packet is shortened.

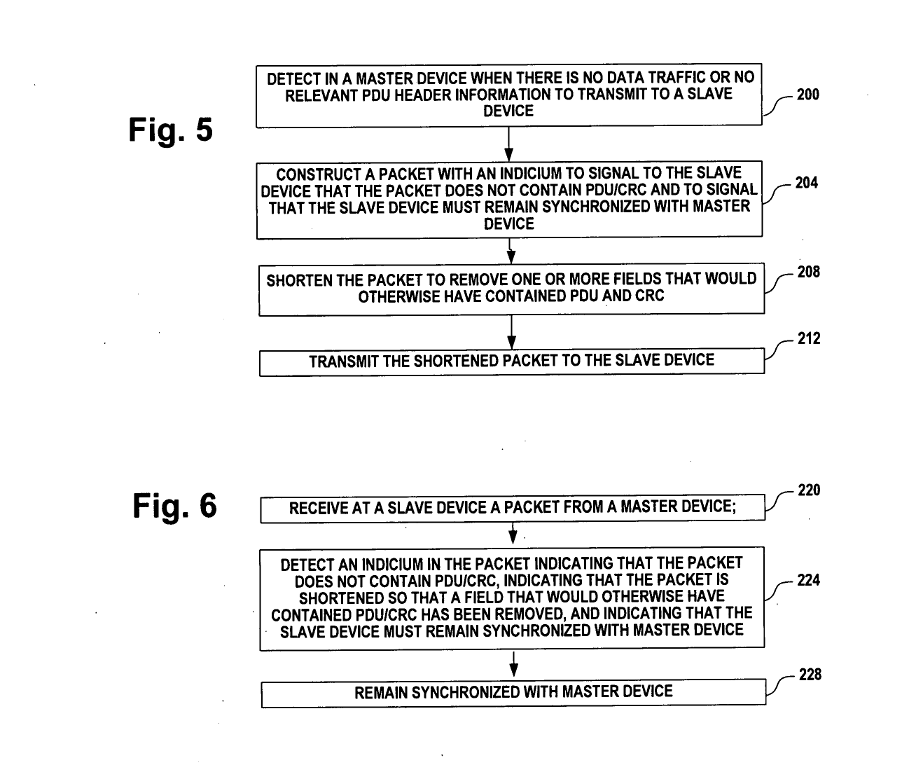

FIG. 5 is an example flow diagram of a procedure at a master device using the Bluetooth Low Energy protocol according to at least one embodiment, to shorten the packet length when there is no data to send, while keeping the communication link alive with the receiving device. The steps of the procedure are as follows:

Step 200: detect in a master device when there is no data traffic or no relevant PDU header information to transmit to a slave device.

Step 204: construct a packet with an indicium to signal to the slave device that the packet does not contain PDU/CRC and to signal that the slave device must remain synchronized with master device.

Step 208: There are at least two different options depending on the embodiment. One option is simply creating the shortened packet in step 204 when step 200 indicates that there is no data to send to the slave device. Another option is to shorten the packet in this step to remove one or more fields that would otherwise have contained PDU and CRC.

Step 212: transmit the shortened packet to the slave device.

FIG. 6 is an example flow diagram of a procedure at a slave device using the Bluetooth Low Energy protocol according to at least one embodiment, to shorten the packet length when there is no payload data to send, while keeping the communication link alive with the receiving device. The steps of the procedure are as follows:

Step 220: receive at a slave device a packet from a master device.

Step 224: detect an indicium in the packet indicating that the packet does not contain PDU/CRC, indicating that the packet is shortened so that a field that would otherwise have contained PDU/CRC has been removed, and indicating that the slave device must remain synchronized with master device.

Step 228: remain synchronized with master device.

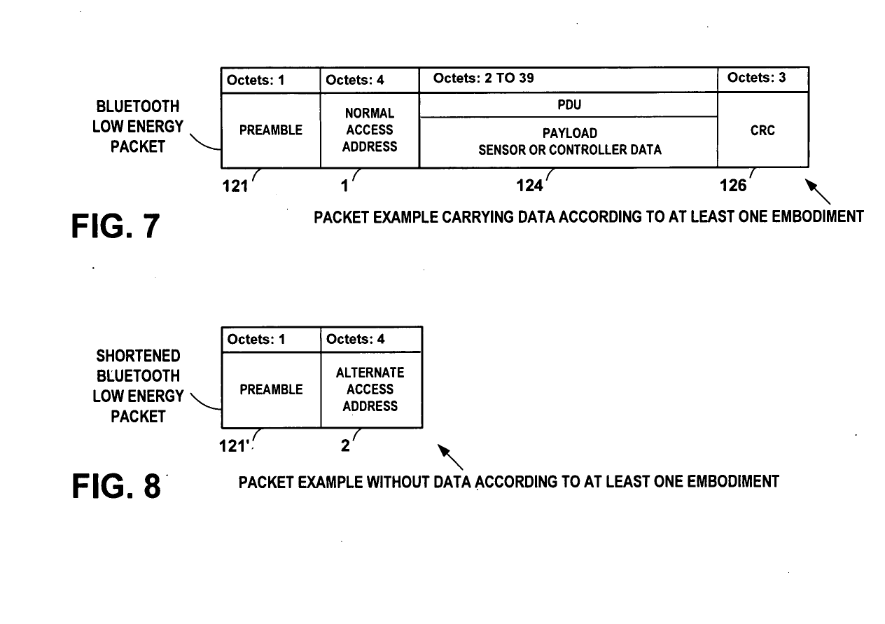

FIG. 7 is an example of the Bluetooth Low Energy packet carrying payload data according to at least one embodiment. The packet includes an 8-bit the preamble 121 used for radio synchronization. The preamble is a fixed zero-one pattern of symbols used to facilitate DC compensation. The packet also includes a 32-bit field for the normal access address 1 used to identify the physical connection between two devices. The normal access address 1 is generated in a connection setup phase. The packet also includes the protocol data unit (PDU) field 124 that carries the payload data. The protocol data unit (PDU) field includes a 16-bit header field, a variable length payload field, and may include an optional 32-bit MIC field. The packet also includes a 24-bit cyclic redundancy code (CRC) field 126 to insure correctness of the PDU.

FIG. 8 is an example of the shortened Bluetooth Low Energy packet without payload data according to at least one embodiment. The shortened Bluetooth Low Energy packet includes an 8-bit the preamble 121′ used for radio synchronization. The preamble is a fixed zero-one pattern of symbols used to facilitate DC compensation. The packet also includes a 32-bit field for the alternate access address 2 used to identify the link between the master device and the slave device and to alert the receiving device that the packet is shortened, does not contain payload data, and that the link is to be maintained alive. The alternate access address 2 is selected by the master device.

According to at least one example embodiment, the master device may construct the alternate access address 2 by adding an integer value to the normal access address 1 of the master device. The master device then must transmit the alternate access address 2 as a control parameter to the receiving slave device, so that the alternate access address 2 may be stored in the slave device along with the normal access address 1. It should be noted that the above is only one of many possible examples of constructing the alternate access address 2.

Upon receiving the alternative access address in the Bluetooth Low Energy data packets for separating PDU containing packets and no PDU containing packets, the slave device is able to recognize normal packets containing PDU from the master because the slave compares the normal access address 1 of the received packet with the copy of the normal access address 1 the slave has stored. The slave device is able to recognize shortened packets without any PDU/CRC sent to it from the master because the slave compares the alternate access address 2 of the received packet with the copy of the alternate access address 2 the slave has stored. If the slave device responds to the master device with a packet that does not contain PDU/CRC, the slave inserts the alternate access address 2 to indicate to the master device that the packet does not contain PDU/CRC and that the packet is shortened. If the slave device responds to the master device with a packet that contains PDU/CRC, the slave inserts the normal access address 1 to indicate to the master device that the packet is a normal packet that contains payload data.

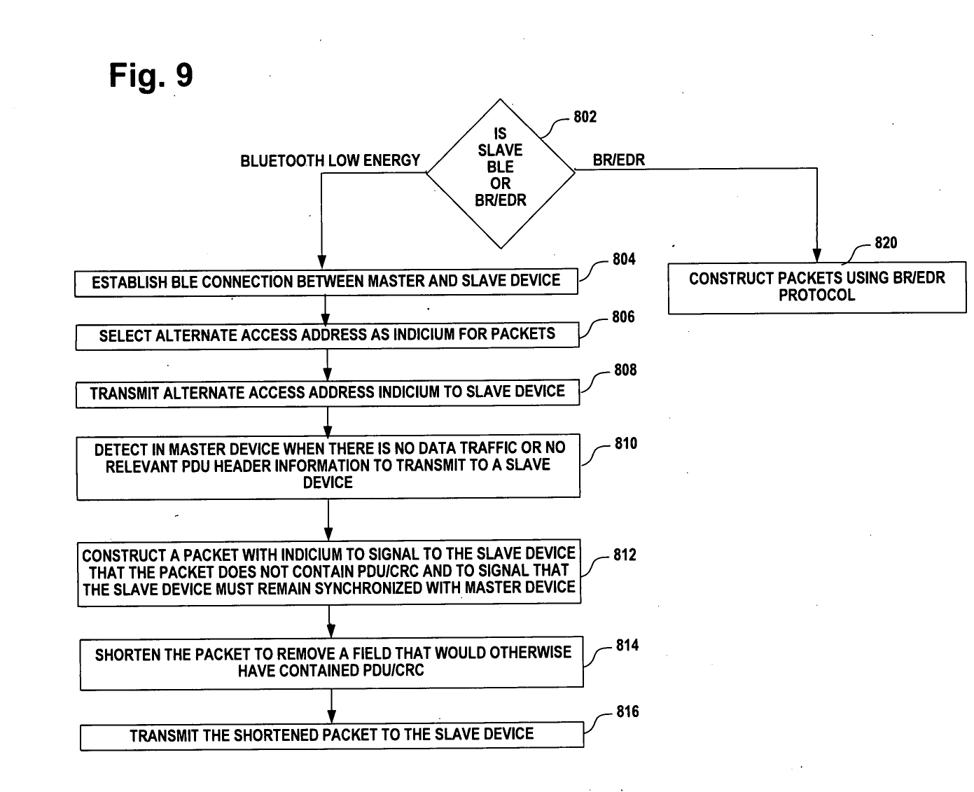

FIG. 9 is an example flow diagram of a procedure at a master device for communicating in the Bluetooth Low Energy protocol with a slave device according to at least one embodiment. The steps of the procedure are as follows:

Step 802: is the slave Bluetooth Low Energy or BR/EDR?

If Bluetooth Low Energy, then:

Step 804: establish connection between master device and slave device.

Step 806: select alternate access address as indicium for packets.

Step 808: transmit alternate access address indicium to slave device.

Step 810: detect in master device when there is no data traffic or no relevant PDU header information to transmit to a slave device.

Step 812: construct a packet with indicium to signal to the slave device that the packet does not contain PDU/CRC and to signal that the slave device must remain synchronized with master device.

Step 814: There are at least two different options depending on the embodiment. One option is simply creating the shortened packet in step 812 when step 810 indicates that there is no data to send to the slave device. Another option is to shorten the packet in this step to remove one or more fields that would otherwise have contained PDU and CRC.

Step 816: transmit the shortened packet to the slave device.

If BR/EDR, then:

Step 820: construct packets using BR/EDR protocol

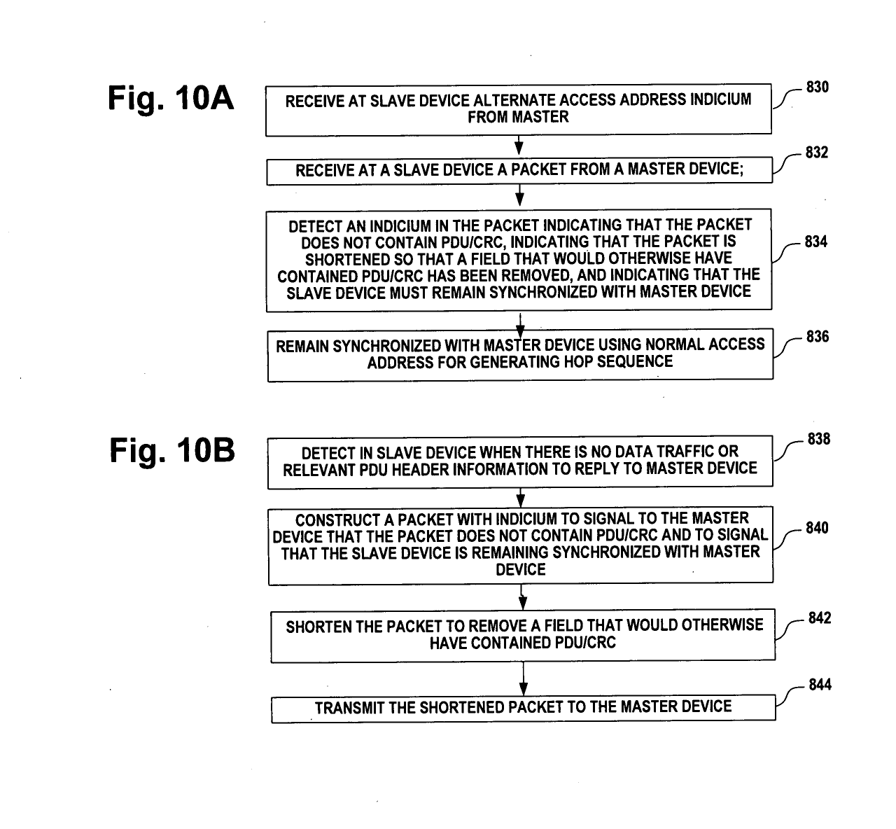

FIG. 10A is an example flow diagram of a procedure at a slave device for detecting a shortened packet according to at least one embodiment. The steps of the procedure are as follows:

Step 830: receive at slave device alternate access address indicium from master.

Step 832: receive at a slave device a packet from a master device.

Step 834: detect an indicium in the packet indicating that the packet does not contain PDU/CRC, indicating that the packet is shortened so that a field that would otherwise have contained PDU/CRC has been removed, and indicating that the slave device must remain synchronized with master device.

Step 836: remain synchronized with master device.

The flow diagram of FIG. 10B is an example of a procedure at a slave device for replying to the master device with a shortened packet indicating there is no PDU/CRC in the packet according to at least one embodiment. The steps of the procedure starting at step 838 are as follows:

Step 838: detect in slave device when there is no data traffic or relevant PDU header information to reply to master device.

Step 840: construct a packet with indicium to signal to the master device that the packet does not contain PDU/CRC and to signal that the slave device is remaining synchronized with master device.

Step 842: There are at least two different options depending on the embodiment. One option is simply creating the shortened packet in step 840 when step 838 indicates that there is no data to send to the master device. Another option is to shorten the packet in this step to remove one or more fields that would otherwise have contained PDU and CRC.

Step 844: transmit the shortened packet to the master device.

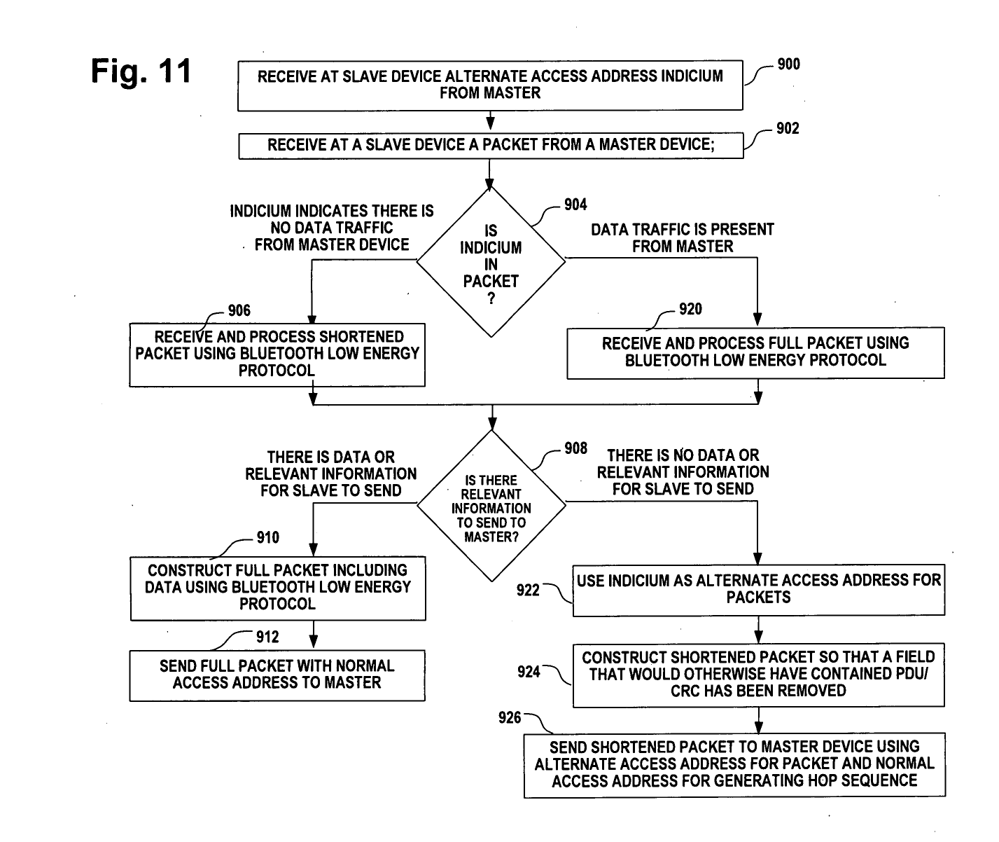

FIG. 11 is an example flow diagram of a procedure at a slave device for detecting either a full packet or a shortened packet and replying to the master device with either a full packet or a shortened packet according to at least one embodiment. The steps of the procedure are as follows:

Step 900: receive at slave device alternate access address indicium from master.

Step 902: receive at a slave device a packet from a master device.

Step 904: is indicium in Packet?

If the Indicium indicates there is no relevant information from master device, then:

Step 906: receive and process shortened packet using Bluetooth Low Energy protocol.

Step 908: is there relevant information to send to master?

If there is data or relevant information for slave to send, then:

Step 910: construct full packet including data using Bluetooth Low Energy protocol.

Step 912: send full packet with normal access address to master.

Back at Step 904: “is indicium in Packet?”,

If data traffic is present from master, then:

Step 920: receive and process full packet using low energy protocol.

At step 908: “is there data or relevant information to send to master?”

If there is no data or relevant information for slave to send, then:

Step 922: use indicium as alternate access address for packets.

Step 924: construct shortened packet so that a field that would otherwise have contained PDU/CRC has been removed. There are at least two different options. One option is simply creating the shortened packet in this step when step 908 indicates that there is no data to send to the master device. Another option is to shorten the packet in this step to remove one or more fields that would otherwise have contained PDU and CRC.

Step 926: send shortened packet to master device using alternate access address for packet and normal access address for generating hop sequence.

In this manner, significant power and interference savings is gained, since there is no need to transmit and receive PDU data elements containing merely null symbols. And, since there is PDU in the packet, there is no need for a CRC in the packet to ensure correctness of the data.

When the sending device determines that it will send a Bluetooth Low Energy protocol packet in the next transmission slot, if the packet only contains unnecessary information that is already known by the receiving device or which can be derived by the receiving device without inspecting the PDU, then the sending device may shorten the packet by omitting the unnecessary information. The shortened condition of the packet will be indicated by using the alternate address 2 for the shortened packet. When the receiving device receives this shortened packet bearing the alternate address 2, the receiving device may infer the omitted information because it is already known to the receiving device or can be derived by the receiving device.

Examples of unnecessary information in the normal packet of FIG. 3, which may be omitted in the shortened packet of FIG. 4, includes:
0x01=LL Data Packet: Continuation of a fragment of an L2CAP message, or an Empty Packet;
More data (MD)=0 indicating the end of connection event;
Next expected sequence number (NESN)=acknowledgement to packet containing no payload
SN=Not relevant, due to packet is not part of the acknowledgement and flow control process
Reserved future use (RFU) not used
Length=0
CRC value may not be relevant here.

When the receiving device receives this shortened packet bearing the alternate address 2, the receiving device may infer the omitted information because it is already known to the receiving device.

Examples of information in the normal packet of FIG. 3, which may indicate that it is not useful to shorten the packet, includes:
Payload data exists;
Previously received payload has not been acknowledged;
Control packet needs to be sent;
More data (MD) bit used keep the connection event open.

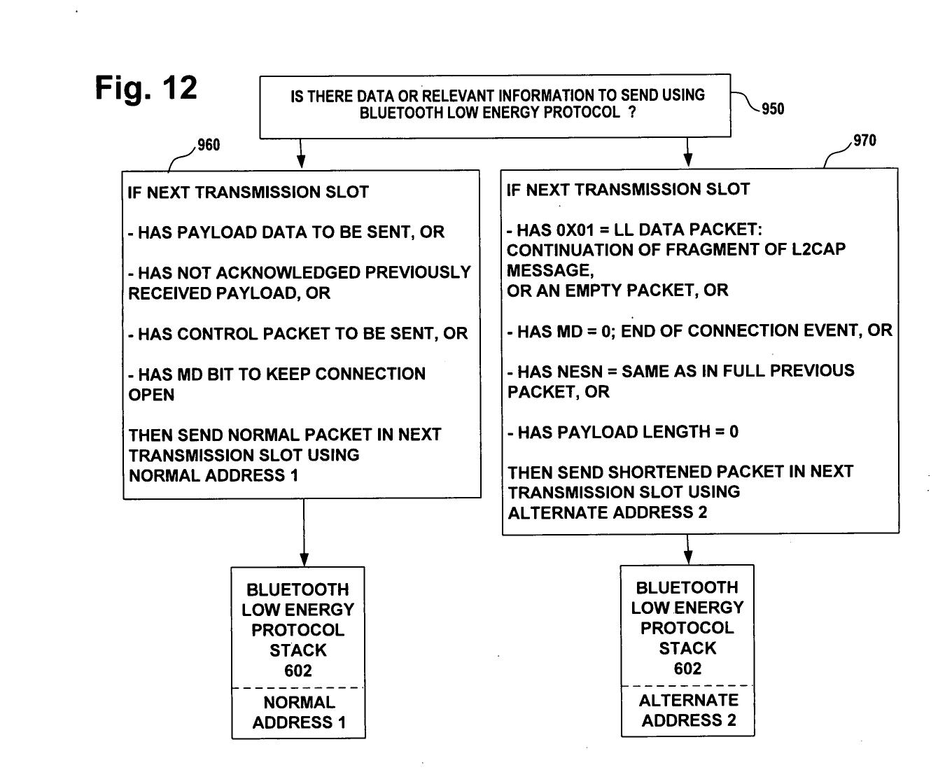

FIG. 12 is an example flow diagram of a procedure that may be used at either or both the slave device and the master device to determine if there is data or relevant information to send using the Bluetooth low energy protocol. The procedure of FIG. 12 may be used to implement step 200 in FIG. 5 for the master device, step 810 in FIG. 9 for the master device, step 838 in FIG. 10B for the slave device, and step 908 in FIG. 11 for the slave device. The steps of the procedure are as follows:

Step 950: Is there data or relevant information to send using Bluetooth low energy protocol?

Step 960: If the next transmission slot has payload data to be sent, or has not acknowledged previously received payload, or has control packet to be sent, or has MD bit to keep connection open, then send a normal packet in the next transmission slot using the normal address 1 in the Bluetooth low energy protocol stack 602.

Step 970, which flows from step 950: If the next transmission slot has 0x01=LL data packet: continuation of fragment of L2CAP message, or an empty packet, and has MD=0 indicating the end of connection event, and previously received payload has been acknowledged, and has payload length=0, then send a shortened packet by omitting the unnecessary information in the next transmission slot and use the alternate address 2 in the Bluetooth low energy protocol stack 602.

When the receiving device receives this shortened packet bearing the alternate address 2, the receiving device may infer the omitted information because it is already known to the receiving device.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
determining, at a sending device having a wireless communication link with a receiving device, that information to be sent in an upcoming transmission slot to the receiving device is already known or derivable by the receiving device;
constructing a shortened packet including a packet preamble field and an access address field including an indicium to signal to the receiving device that said information already known or derivable by the receiving device has been omitted in the shortened packet; and
transmitting the shortened packet to the receiving device.

2. The method of claim 1, wherein the indicium is a different access address and the shortened packet only contains a preamble and the different access address.

3. The method of claim 1, wherein the constructing step removes a field that would otherwise have contained a cyclic redundancy code.

4. The method of claim 1, wherein the indicium signals that the receiving device must remain synchronized with sending device to enable it to respond to the sending device.

5. A method, comprising:
receiving at a receiving device a packet from a sending device;
detecting an indicium in the packet indicating that information already known or derivable by the receiving device has been omitted in the packet, and indicating that the receiving device must remain synchronized with sending device; and
remaining synchronized with sending device.

6. The method of claim 5, wherein the indicium is a different access address an the packet only contains a preamble and the different access address.

7. The method of claim 5, wherein the indicium indicates that the packet is shortened so that a field that would otherwise have contained a cyclic redundancy code has been removed.

8. The method of claim 5, which further comprises:
responding back to the sending device with a similarly shortened packet containing an indicium indicating that the receiving device has omitted information already known or derivable by the sending device.

9. A device, comprising:
a transceiver; and
a processor configured to control the operation of the transceiver to:
determine, at the device having a wireless communication link with another device, that information to be sent in an upcoming transmission slot to the other device is already known or derivable by the other device;
construct a shortened packet including a packet preamble field and an access address field including an indicium to signal to the other device that said information already known or derivable by the other device has been omitted in the shortened packet; and
transmit the shortened packet to the other device.

10. The device of claim 9, wherein the indicium is a different access address and the shortened packet only contains a preamble and the different access address.

11. The device of claim 9, wherein the constructing step removes a field that would otherwise have contained a cyclic redundancy code.

12. The device of claim 9, wherein the indicium signals that the other device must remain synchronized with the first said device to enable it to respond to the first said device.

13. A device, comprising:
a transceiver; and
a processor configured to control the operation of the transceiver to:
receive at a device a packet from another device;
detect an indicium in the packet indicating that information already known or derivable by the device has been omitted in the packet, and indicating that the device must remain synchronized with other device; and
remain synchronized with the another device.

14. The device of claim 13, wherein the indicium is a different access address and the packet only contains a preamble and the different access address.

15. The device of claim 13, wherein the indicium indicates that the packet is shortened so that a field that would otherwise have contained a cyclic redundancy code has been removed.

16. The device of claim 13, which further comprises:
said processor configured to control the operation of the transceiver to:
respond back to the another device with a similarly shortened packet containing an indicium indicating that information already known or derivable by the another device has been omitted.

17. A computer readable medium, comprising:
a computer readable medium configured to store program instructions, which when executed by a computer processor, perform the steps of:
determining, at a sending device having a wireless communication link with a receive device, that information to be sent in an upcoming transmission slot to the receive device is already known or derivable by the receive device;
constructing a shortened packet including a packet preamble field providing link synchronization information to the receive device for remaining synchronized with the sending device and an access address field including an indicium to signal to the receive device that said information already known or derivable by the receive device has been omitted in the shortened packet; and
transmitting the shortened packet to the receive device.

18. A computer readable medium, comprising:
a computer readable medium configured to store program instructions, which when executed by a computer processor, perform the steps of:
receiving at a receive device a packet from a sending device;
detecting an indicium in the packet indicating that information already known or derivable by the receive device has been omitted in the packet, and indicating that the receive device must remain synchronized with sending device; and
remaining synchronized with sending device.
